(19) United States
(12) Patent Application Publication
(10) Pub. No.: US 2009/0029769 A1
(43) Pub. Date: Jan. 29, 2009

(54) Controlling avatar performance and simulating metabolism using virtual metabolism parameters

(75) Inventor: Christian Muller, Stallikon (CH)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(73) Assignee: Empire of Sports developments Ltd.

(21) Appl. No.: 12/052,227

(22) Filed: Mar. 20, 2008

Related U.S. Application Data
(60) Provisional application No. 61/016,158, filed on Dec. 21, 2007.
(60) Provisional application No. 61/016,186, filed on Dec. 21, 2007.

(30) Foreign Application Priority Data
Jul. 27, 2007 (CH) CH 01208/07

(51) Int. Cl. A63F 13/10; G06F 19/00

(52) U.S. Cl. 463/31; 463/1

(57) ABSTRACT

Systems and methods are described for controlling the performance of an avatar in an electronic game. The avatar is equipped with a virtual metabolism that includes one or more metabolic parameters, which simulate real-life metabolic processes. Actions implemented by a user playing the electronic game cause changes in the metabolic parameters which affects and controls the performance of the avatar in virtual athletic activities. The electronic game can further include both real-life and virtual items available for purchase by the user to enhance the user's and the avatar's athletic performance.

### FIELD OF THE INVENTION

The invention relates to methods and systems for simulating human metabolic processes in an avatar. More particularly, the invention relates to methods and systems for controlling athletic performance of an avatar based upon simulated human metabolic processes.

### BACKGROUND

Electronic games, e.g., video games, computer-based games, and internet-based games, have become a ubiquitous part of modern society and as the technology has improved for creating and delivering these games, concurrent increases have occurred in the number of users and in the abilities of games and their creators to simulate real-world activities. Naturally, sports-related games are among the most popular form of electronic games played by users. The performance of virtual characters, also known as avatars, in electronic games is controlled by algorithms run by computer software. Often these performance parameters are unrelated to real-life considerations for actual athletes, such as metabolic parameters including hydration, energy, and cardiovascular and respiration parameters. Due to the failure to incorporate real-life metabolic parameters, when simulating real-life sports, conventional electronic games provide an unrealistic portrayal of the athletic performance of players in the game. Methods and systems are needed to accurately simulate the metabolic processes that affect real athletic performance for purposes of controlling an avatar's performance in a virtual sport so as to provide a more realistic electronic sports gaming experience for users. Conventional electronic games also fail to realistically simulate the development of an athlete's various muscle groups through exercise, training, and competition.

### SUMMARY

The technology pertains to systems and methods for controlling avatar (virtual player) performance using avatar metabolism parameters that are tracked for each avatar in a videogame. The system includes a game server, video game software, at least one computer (client), at least one control unit, and a display screen. The avatar metabolism parameters also includes short-term parameters, e.g., power demanded, glucose used, ATP (adenosine triphosphate), oxygen, and lactic acid quantity in muscle, and long-term parameters, e.g., maximum oxygen supply per muscle weight, aerobic ATP supply, and glucose digestion rate. The computer uses mathematical formulae to calculate the value for each parameter.

Most of these short-term and long-term parameters will be calculated and monitored by the computer and will not be displayed for viewing by a user. Instead, a metabolism gauge or gauges may appear on the display screen during the videogame to show the user the level (or value) of one or more metabolism parameters for the avatar. The gauges provide less technical groupings or combinations of parameters for display to the user. The gauges may provide the user with information concerning the avatar's muscle status, heart rate, and fatigue level. The level of each of these gauges is determined by underlying mathematical formulas used by the computer to calculate the value for each parameter. Avatar performance during the game is affected, at least in part, by the metabolism parameters calculated and monitored by the computer using the videogame software.

The value for each of the avatar's metabolism parameters is determined, at least in part, by: (1) the avatar's nutrition (foods consumed such as carbohydrates, fats, and proteins), (2) aerobic and anaerobic ATP production (energy production for muscles through consumption of creatine phosphate, glycolic oxidation, and fat transformation), and (3) hydration through water consumption. The performance of warm-up exercises or the consumption of an energy drink by the avatar may also affect the avatar's performance by modifying the value of the avatar's metabolism parameters.

The various metabolism parameters affect different muscle groups, for example, slow-twitch (type I) versus fast-twitch (type II), in different ways. Increased activity and lack of activity by the avatar during the game affect the avatar's performance through changes in the avatar's metabolism parameters.

An advantage of the systems and methods described herein lies in their ability to provide a more realistic sports gaming experience. Sports enthusiasts will be attracted to the manner in which the avatar and the avatar's metabolism accurately simulate the metabolism and performance of a real human athlete. The systems and methods described herein are also advantageous because they promote athleticism among the users of the electronic game by encouraging the purchase of sport-related items including apparel, footwear, and sports equipment. Another advantage of the avatar and its metabolism are the educational aspects in which the user is taught the importance of a healthy diet and regular exercise, both of which are necessary for successful performance of the avatar during competition in the electronic game.

Still another advantage of the systems and methods described herein is their ability to more accurately simulate the progress in improvement of an athlete as the avatar exercises, practices, plays, and increases in fitness, stamina, performance, and skill level.

Yet another advantage of the systems and methods described herein is the ability to quickly and easily enhance the avatar object and metabolism classes via download to the client from the server.

Another advantage of the systems and method described herein is that performance of the electronic game is improved by reducing data exchange between the client computer and game server during the course of gameplay. Performance of the electronic game is improved by retaining data related to changes in the avatar's long-term metabolic parameters on the client until the gameplay has ended. Real-time transfer of this user-specific long-term metabolic parameter data from the client to the game server during gameplay would result in slower performance and a larger usage of bandwidth over the telecommunications network. Data related to changes in the avatar's long-term metabolic parameters is uploaded to the game server after gameplay has been ended by the user but before the user logs out. Changes in the avatar's short-term metabolic parameters are not transferred to the game server but remain on the client. This arrangement permits the electronic game to use more bandwidth on the telecommunications network for exchanging current game status data, and in particular, positional data for the avatars and game objects (e.g., a basketball), during gameplay, thereby providing users with a more realistic athletic gaming experience particularly during multi-player gameplay.

Accordingly, the invention features a method for simulating real-life athletic performance in an electronic game. The method includes the step of providing (i) an electronic game comprising software installed on a computer and (ii) one or more devices for playing, displaying, and allowing a user to interact with the electronic game. The method further includes the steps of equipping an avatar in the electronic game with a virtual metabolism that includes at least one metabolic parameter, and controlling the performance of the avatar via synergistic user-selected actions and changes in a value of the at least one metabolic parameter.

Another method of the invention includes a step wherein the at least one metabolic parameter includes a computer-simulated physiological metabolic process of a real human athlete.

Another method of the invention includes a step wherein the simulated physiological metabolic process is one or more of the following: avatar's total mass, muscle volume as a share of total mass, glycogen share in muscle, muscle glycogen level, liver glycogen level, blood glycogen level, total glycogen level, total glucose storage, body fat share of total mass, amount of body fat/fatty acid, adenosine triphosphate (ATP) available per grams of fatty acid, total fatty acid storage, energy efficiency, energy release per amount of ATP, maximum oxygen supply per muscle weight, oxygen supply kinetic rate, minimum heart rate, maximum heart rate, heart rate kinetic rate, normal creatine phosphate level, maximum creatine phosphate supply, creatine phosphate restoration factor, creatine phosphate restoration limit, normal fatty acid level, fat rate counter speed, ATP supply from fatty acid, fatty acid restore rate, anaerobic decay accelerator, fat storage transfer, glucose molecular weights, glucose restore rate, aerobic ATP supply, carbohydrates-to-glucose transfer rate, glucose digestion rate, lactacidic ATP supply, lactate decomposition rate, muscle lactate limit, absolute muscle lactate limit, share of lactate used as energy, power normalization factor to simulate active recovery, and hydration.

Another method of the invention includes the step of permitting the user to select the quantity and types of food consumed by the avatar, wherein the food in the electronic game is virtual food having computer-simulated nutritional properties.

Another method of the invention includes permitting the user to select the quantity and types of liquid beverage consumed by the avatar, wherein the liquid beverage in the electronic game is virtual liquid beverages having computer-simulated nutritional properties.

Another method of the invention includes the step of depending the quantity of virtual food that the avatar must consume upon the avatar's muscle volume.

Another method of the invention includes the step of changing the avatar's total mass as a variable that is dependent upon the quantity and types of food and liquid beverage selected by the user and consumed by the avatar.

Another method of the invention includes the step of powering the avatar's performance of virtual athletic actions by instructing the avatar to produce virtual energy by metabolizing stored virtual creatine phosphate.

Another method of the invention includes the step of powering the avatar's performance of virtual athletic actions by instructing the avatar to produce virtual energy by metabolizing stored virtual glucose.

Another method of the invention includes the step of powering the avatar's performance of virtual athletic actions by instructing the avatar to produce virtual energy by metabolizing stored virtual fatty acids.

Another method of the invention includes the step of powering the avatar's performance of virtual athletic actions by instructing the avatar to produce virtual energy by metabolizing stored virtual glucose through simulated aerobic respiration when the avatar has performed virtual athletic actions to oxygenate the avatar's virtual muscle.

Another method of the invention includes the step of powering the avatar's performance of virtual athletic actions by instructing the avatar to produce virtual energy by metabolizing stored virtual glucose through simulated anaerobic respiration when the avatar requires immediate access to virtual energy and the avatar has not performed virtual athletic actions to oxygenate the avatar's virtual muscle.

Another method of the invention includes the step of including in the electronic game one or more metabolism gauge displays to provide the user with information concerning the at least one metabolic parameter, the at least one metabolic parameter being selected from at least one of the following: the avatar's muscle status, heart rate, fatigue level, and hydration.

Another method of the invention includes the step of equipping the avatar with a plurality of muscle groups, wherein each of the plurality of muscle groups contains at least one type of virtual muscle selected from the following: slow-twitch virtual muscles that are fatigue-resistant for long-term athletic performance by the avatar and fast-twitch virtual muscles for short-term athletic performance by the avatar.

Another method of the invention includes the step of assigning to each of the plurality of muscle groups (i) a first muscle power parameter that includes a range of values related to the percentage of the avatar's virtual muscle mass dedicated to performing slow and long-term athletic performance, and (ii) a second muscle power parameter that includes a range of values related to the percentage of the avatar's virtual muscle mass dedicated to performing fast and immediate athletic performance.

Another method of the invention includes the step of training the avatar through user-selected actions.

Another method of the invention includes the step of improving the avatar's athletic performance through the performance of virtual athletic actions.

Another method of the invention includes the step of defining a maximum muscle mass that can be attained by the avatar with respect to changes in muscle power parameters related to the avatar's fast-twitch and slow-twitch virtual muscles.

Another method of the invention includes the step of assigning to each of the plurality of muscle groups a third muscle power parameter that defines the maximum muscle mass that can be attained by the avatar and defining the third muscle power parameter as a sum of the first and second muscle power parameters.

Another method of the invention includes the step of linking the first and second muscle power parameters, once maximum muscle mass has been attained by the avatar, so that an increase in one muscle power parameter causes a corresponding decrease in the other muscle power parameter so that a predetermined value for maximum muscle mass cannot be exceeded.

Another method of the invention includes the step of making the electronic game accessible via a telecommunications network.

Another method of the invention includes the steps of using the computer to calculate and monitor the value of the at least one metabolic parameter, altering the value of the at least one metabolic parameter based upon the input of user-selected actions in conjunction with predetermined metabolic parameter effects, and changing the performance of the avatar in connection with changes in the value of the at least one metabolic parameter.

In another aspect, the invention features a method for simulating real-life athletic performance in an electronic game. The method includes the step of providing (i) software that includes an electronic game installed on a computer and (ii) one or more devices for playing, displaying, and allowing a user to interact with the electronic game. The method further includes the steps of equipping an avatar in the electronic game with a virtual metabolism having at least one metabolic parameter, controlling the performance of the avatar via synergistic user-selected actions that cause changes in a value of the at least one metabolic parameter, and making available for purchase by the user virtual items that when purchased and used by the avatar improve the avatar's performance in the electronic game.

Another method of the invention includes the step of making available for purchase by the user real-life versions of the virtual items.

Another method of the invention includes the step of selling virtual items and real-life versions of the virtual items that are real-life and simulated apparel, footwear, sports equipment, food, liquid beverages, and sports accessories.

In another aspect, the invention features a computer readable medium that is a computer program means for controlling a computer so that the computer generates an avatar. The avatar includes a virtual metabolism having at least one virtual metabolic parameter, which is a computer-simulated physiological metabolic process of a real athlete.

In another aspect, the avatar further includes two types of virtual muscles: slow-twitch virtual muscles that are fatigue-resistant for long-term athletic performance by the avatar and fast-twitch virtual muscles for short-term athletic performance by the avatar.

In another aspect, the invention features a gaming device for marketing and selling at least one item displayed in an electronic game. The gaming device includes a computer by which the electronic game is accessed by a user, a display device connected to the computer, at least one input device connected to the computer, and an avatar stored on the computer and controlled by manipulation of the at least one input device by the user. The avatar includes a virtual metabolism. The purchase of items being marketed and sold via the electronic game enhances the avatar's athletic performance in a virtual sport.

In another aspect, the items being marketed and sold via the electronic game include both virtual items to be used by the avatar and corresponding real-life versions of virtual items for use by a human.

In another aspect, the invention features an electronic game system having at least one server connected to a telecommunications network, a computer that is connected to the telecommunications network and which includes software means by which an electronic game is remotely accessed on the at least one server by a user, a display device connected to the computer, at least one input device connected to the computer, and a computer program means for controlling the computer so that the computer generates an avatar that is stored on the computer and controlled by manipulation of the at least one input device by the user. The avatar includes a virtual metabolism. The electronic game system further includes a first data store associated with the server and configured to store user-specific long-term avatar metabolism parameters and a second data store associated with the computer and configured to store short-term avatar metabolism parameters.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a schematic diagram of the avatar's production of virtual ATP from virtual food and virtual oxygen supply to power the avatar's athletic actions.

FIG. 2 is an example of a metabolism gauge display indicating the avatar's muscle status, fatigue level, heart rate, and hydration level.

FIGS. 3A-3B are tables illustrating examples of units and typical values that can be used in calculating and monitoring an avatar's virtual metabolism parameters within the electronic game.

FIG. 4 is a schematic diagram of the connection of hardware and software components of the electronic game.

FIGS. 5A-5C are of a flow diagram showing the sequential exchange of data between a client and a server for a new user.

FIGS. 6A-6C are of a flow diagram showing the sequential exchange of data between a client and a server for an existing user.

FIGS. 7A-7C are of a flow diagram showing the parallel development of type I and type II virtual muscle groups depending upon the types of activities engaged in by an avatar.

FIG. 8 is a table showing an avatar's usage of type I and type II virtual muscle groups during certain activities performed in connection with several sports games of an electronic game.

### DETAILED DESCRIPTION

The invention provides systems for controlling the performance of a virtual character, also called an avatar, in an electronic game. In one embodiment, the avatar has a virtual metabolism including at least one virtual metabolic parameter. The avatar is an object constructed from a software programming language such as C++. The appearance of the avatar is predetermined and stored by the electronic game. In another embodiment, the appearance of the avatar can be selected by a user of the electronic game. The avatar can be programmed to simulate the appearance and performance of actual human athletes. The electronic game includes client-side software that is installed on the user's computer and server-side software that is installed on a remote computer or game server that is accessible via a global telecommunications network such as the internet. The avatar is controlled by both the computer and by the user. The user controls the actions and performance of the avatar by selecting the activities in which the avatar engages. The user's input using one or more input devices connected to a gaming device corresponds to an amount of energy or power needed for the avatar to succeed in completing a particular athletic action. For example, the user may press a button on a game control a sufficient number of times to cause the avatar to swing a golf club for a long drive. The computer controls the performance of the avatar in completing activities, for example, athletic and sports-related activities, by enacting a predetermined, preprogrammed reaction of the avatar in response to user-defined input in the form of user-selected actions.

In an exemplary embodiment, the virtual metabolism of the avatar includes a plurality of virtual metabolic parameters each of which simulates a real-life physiological metabolic process of a human being. The virtual metabolic parameters are classes also written in a software programming language such as C++, and form part of the avatar class (also called object). The real-life physiological metabolic processes simulated by the virtual metabolism of the avatar can include, for example, the avatar's total mass, muscle volume as a share of total mass, glycogen share in muscle, muscle glycogen level, liver glycogen level, blood glycogen level, total glycogen level, total glucose storage, body fat share of total mass, amount of body fat/fatty acid, adenosine triphosphate (ATP) available per grams of fatty acid, total fatty acid storage, energy efficiency, energy release per amount of ATP, maximum oxygen supply per muscle weight, oxygen supply kinetic rate, minimum heart rate, maximum heart rate, heart rate kinetic rate, normal creatine phosphate level, maximum creatine phosphate supply, creatine phosphate restoration factor, creatine phosphate restoration limit, normal fatty acid level, fat rate counter speed, ATP supply from fatty acid, fatty acid restore rate, anaerobic decay accelerator, fat storage transfer, glucose molecular weights, glucose restore rate, aerobic ATP supply, carbohydrates-to-glucose transfer rate, glucose digestion rate, lactacidic ATP supply, lactate decomposition rate, muscle lactate limit, absolute muscle lactate limit, share of lactate used as energy, power normalization factor to simulate active recovery, and/or hydration. The electronic game can monitor and calculate values for one, two, three, four, five, or more of these virtual metabolic parameters. The majority of these virtual metabolic parameters will not include any visible means of detection or measurement, but will be calculated and monitored by the electronic game. In one embodiment, a numeric value for one or more of the virtual metabolic parameters may be displayed in the form of one or more gauges shown or accessible to the user during play of the electronic game. As explained in further detail below (see Tables 1-16), these simulated physiological metabolic processes are calculated by the electronic game using one or more mathematical formulas assigned for the determination of the value of each virtual metabolic parameter.

The avatar's virtual metabolism parameters include both long-term parameters having values that change slowly and short-term parameters that fluctuate in real time while the avatar is engaged in athletic activity. Examples of short-terms parameters that may be calculated and monitored by the electronic game as the avatar engages in athletic activity include power demanded by the avatar, virtual ATP, virtual oxygen supply, virtual glucose used by the avatar, and lactate quantity in the avatar's virtual muscle groups. Examples of long-term parameters can include glucose digestion rate, aerobic ATP supply, and maximum virtual oxygen supply per muscle weight of the avatar. Long-term parameters for the avatar are programmed to improve during sequential sessions of gameplay of the electronic game as the user directs the avatar to engage in additional virtual training exercises completed over time.

Printed material such as a book or pamphlet may be provided to the user of the electronic game to provide instructions for controlling the avatar, describe game rules, and explain how the virtual metabolic parameters are calculated and how changes in the value of each virtual metabolic parameter affect the avatar's performance. Alternatively, the instructions may be accessed by the user via electronic documents installed and stored on the computer or downloaded from a communications network.

In an exemplary embodiment, the avatar includes two types of virtual muscles. These two types of virtual muscles include slow-twitch (type I) virtual muscles that are fatigue-resistant for long-term athletic performance by the avatar and fast-twitch (type II) virtual muscles for short-term athletic performance by the avatar. Whereas type I virtual muscles are used by the avatar for longer term athletic activities such as distance running, the type II virtual muscles can be optimized for short term usage, for example, as in sprinting.

The invention also provides devices for marketing and selling at least one item displayed in an electronic game. In one embodiment, the device include a computer by which the electronic game is accessed by a user, a display device connected to the computer, and at least one input device connected to the computer. The device further includes an avatar stored on the computer and controlled by manipulation of the input device by the user. The avatar includes a virtual metabolism such that purchasing and using items being marketed and sold via the electronic game enhances the avatar's athletic performance in a virtual sport. In an exemplary embodiment, these items are virtual items, for example, apparel, footwear, sports equipment, food, liquid beverages, and sports accessories, that can be purchased and selected for utilization by the avatar's user to increase the avatar's skills, performance, and/or energy. The items available for purchase may also be selected by the user with the effect of reducing the avatar's fatigue level.

In another embodiment, the items being marketed and sold via the electronic game may include corresponding real-life versions of the aforementioned virtual items for use by a human. Because the electronic game is capable of data exchange between the client and the game server via the telecommunications network, the user can purchase these real-life products directly through the game interface. In another embodiment, the game interface can include a virtual mall in which the real-life products may be viewed and purchased by the user.

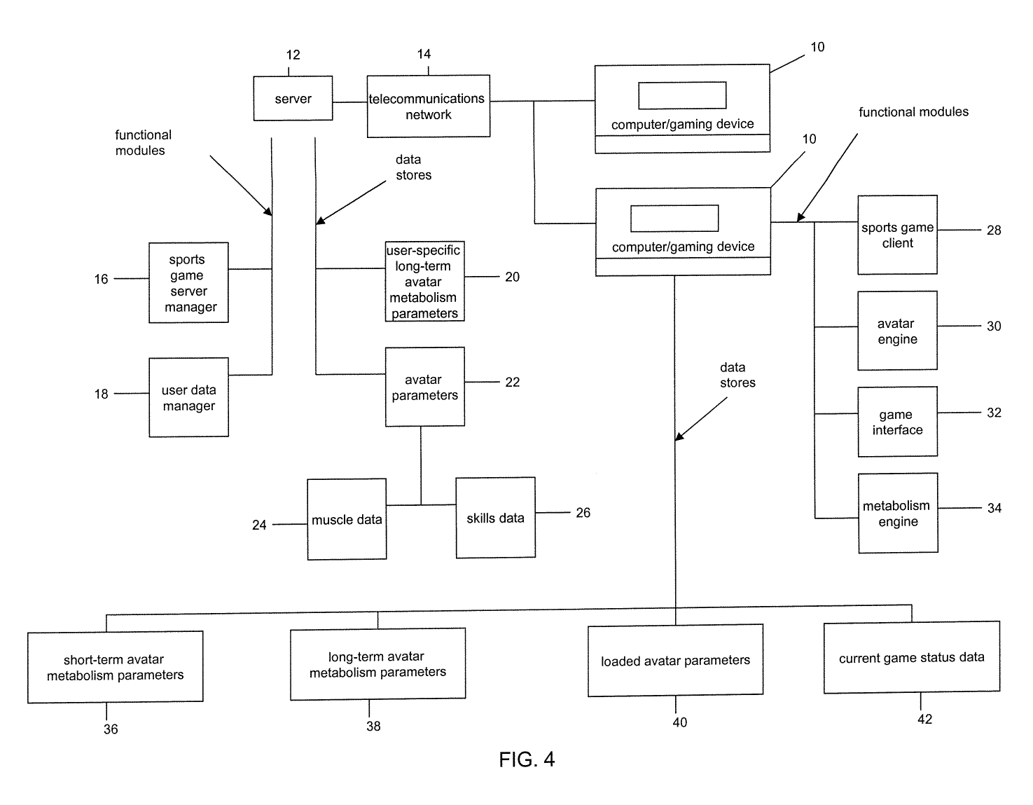

The computer (also called client) by which the electronic game is accessed may be selected from among a personal computer, a handheld computer, a dedicated gaming console device, a handheld gaming device, a personal digital assistant, or a communication terminal such as a cellular phone. In the illustrative embodiment shown in FIG. 4, the computer 10 is connected to the game server 12 via the telecommunications network 14 over which data exchange occurs between the client and the game server. In one embodiment, the electronic game may include a distributed architecture having multiple game servers or even separate servers dedicated to game- and avatar-related data storage and also to network traffic management. The game server includes functional modules such as a sports game server manager 16 and user data manager 18 as well as data stores for user-specific long-term avatar metabolism parameters 20 and other avatar parameters 22 such as muscle data 24 and skills data 26. At first use, the client downloads an installation file from the game server. The installation file includes executables that create and install on the client functional modules that include a sports game client 28, an avatar engine 30, a game interface 32, and a metabolism engine 34. Software initially downloaded by the client from the game server also permits certain data stores to be created by the client including data store structures for short-term and long-term metabolism parameters 36 and 38, loaded avatar parameters 40, and current game status data 42. Current game status data includes positional data for the user's avatar, other user- and computer-controlled avatars, the avatars' body parts, and a virtual ball or other game object.

In an exemplary embodiment, an electronic game system includes at least one server and at least one computer, which are connected to a telecommunications network. The computer includes software by which an electronic game, e.g., a sports video game, is remotely accessed on the at least one server by a user. The electronic game system also includes a display device connected to the computer, at least one input device connected to the computer, and a computer program for controlling the computer so that the computer generates an avatar that is stored on the computer and controlled by manipulation of the at least one input device by the user. The avatar includes a virtual metabolism. The electronic game system further includes a first data store associated with the server and configured to store user-specific long-term avatar metabolism parameters and a second data store associated with the computer and configured to store short-term avatar metabolism parameters.

In an exemplary embodiment, the software of the electronic game is written in the C++ and Lua programming languages. Software forming part of the server code is written in the Java programming language. Data is exchanged between a client (e.g., the user's computer) and the server using an encrypted proprietary protocol that is embedded in TCP/IP datagrams. Interface data may be exchanged using the secured HTTPs protocol.

In the exemplary embodiment, the avatar is defined by a single class, or object, written in the C++ programming language. The avatar class also contains an inventory class. The inventory class further includes elements of an item class. The avatar's virtual metabolism is represented by attributes of the avatar class. In addition to the avatar class, the electronic game further includes classes (objects), game loops and middleware, which are also written in the C++ programming language. The middleware includes, for example, three-dimensional (3D) graphics, physics, a user interface, and network communication, which are used to connect components of the electronic game software so that the components can interact via the telecommunications network. The C++ code structure of the electronic game is divided into a client part, which is run on the user's computer, and a server part, which is run on a platform. The platform can include both software and hardware components of the electronic game. Long-term virtual metabolism parameters are loaded onto the client.

The electronic game is accessed via a telecommunications network, for example, the internet, an intranet, or a local area network (LAN). The electronic game is installed directly on the client computer but include software, such as the sports game client, and data, such as current game status data, as well as hardware for connecting the electronic game to the telecommunications network to permit gameplay against other users in different locations.

The invention further provides a method for simulating real-life athletic performance in an electronic game. The method includes the step of providing an electronic game that includes software installed on a computer (the client) and one or more devices for playing, displaying, and allowing a user to interact with the electronic game. Another step of the method includes equipping an avatar in the electronic game with a virtual metabolism having at least one metabolic parameter. Another step of the method includes controlling the performance of the avatar via synergistic user-selected actions and changes in a value of at least one metabolic parameter as calculated by software installed on the client. In one step of the method, the metabolic parameters of the avatar's virtual metabolism each simulate a real-life physiological metabolic process.

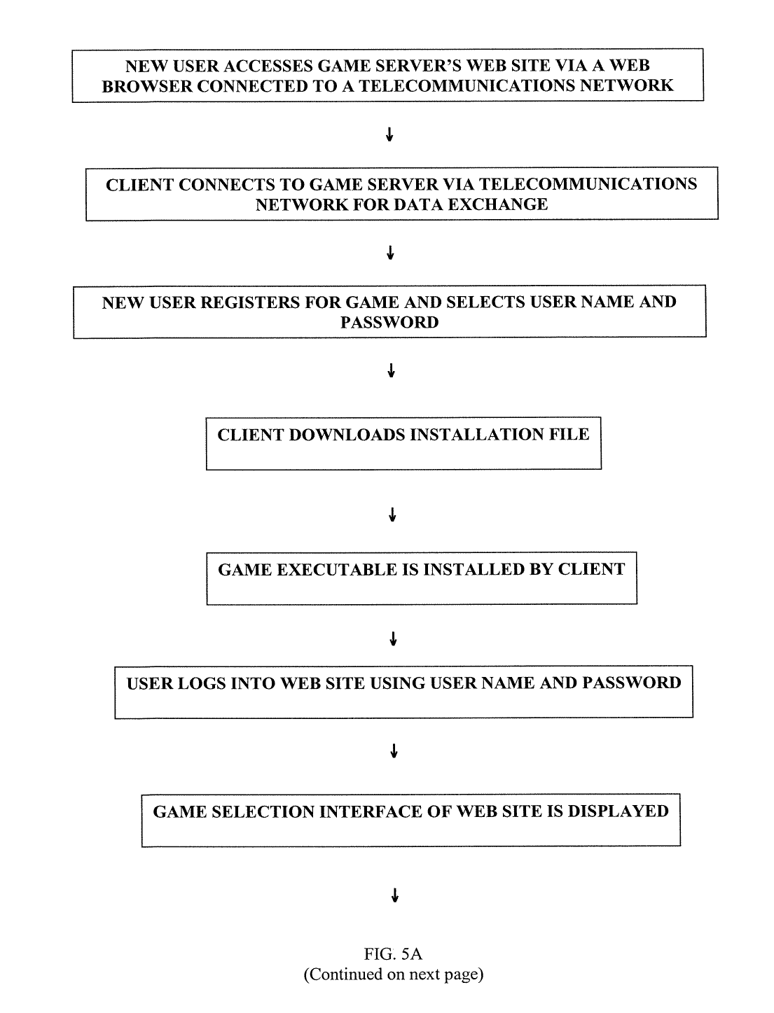

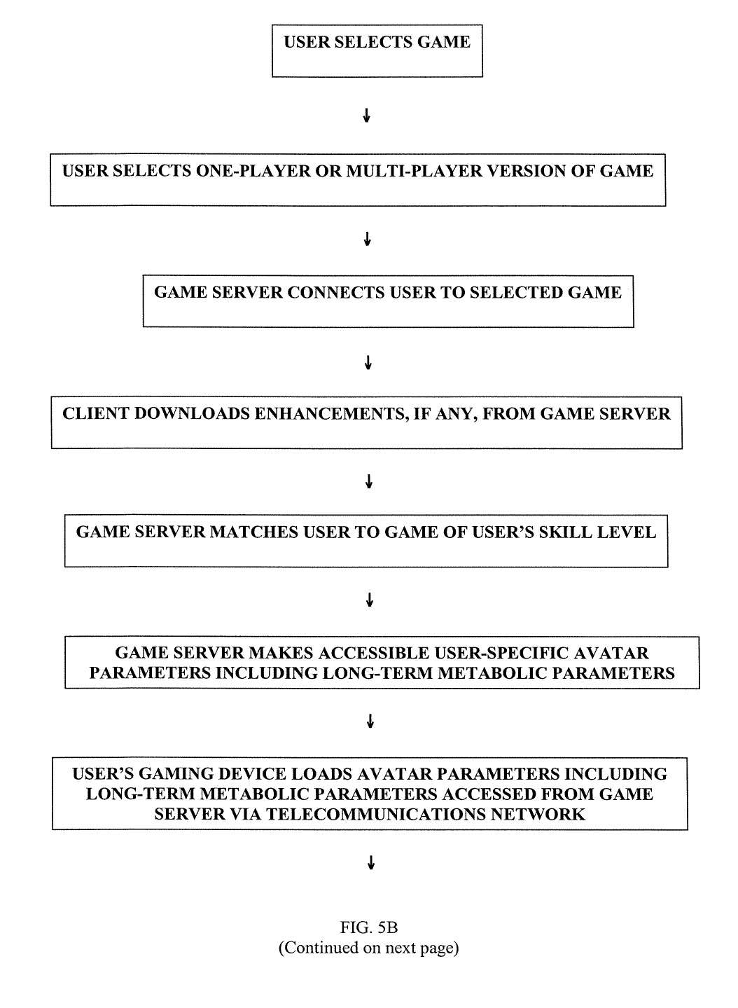

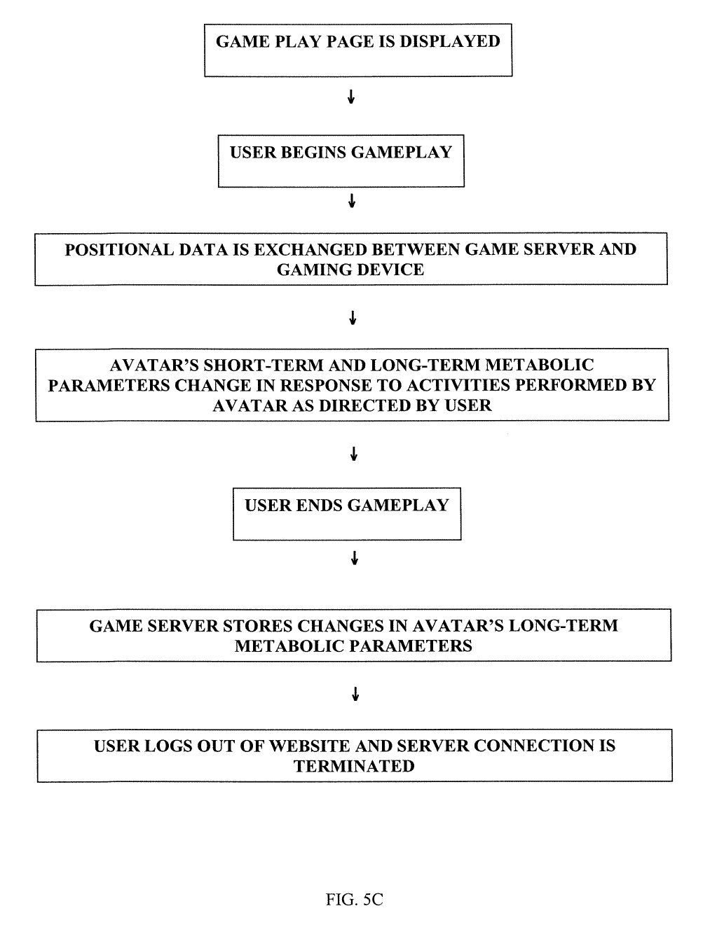

As shown in FIGS. 5A-5C, in an initial step of the method, a new user uses a client computer having a web browser and connected to a telecommunications network, such as the Internet, to access a game server that is also connected to the telecommunications network. The client connects to the game server through a web site for purposes of data exchange. The new user registers through the website to be able to play the game, and during registration, provides certain personal, identifying information in response to questions or prompts provided by the game server through the web site. The new user also selects a unique user name and password to obtain future access to the user's account. In an alternative step of the method, a service provider for the electronic game selects and assigns to each user a unique user name and password. Once registration is complete, the client downloads an installation (or install) file, which is described in further detail below. Upon completion of the download, the client installs one or more game executables that are part of the installation file. The foregoing steps of this paragraph are performed only once unless the user uninstalls the electronic game software from the client or cancels the user's account, in which event the user will be required to perform one or more of these steps again, as relevant, to regain access to the electronic game.

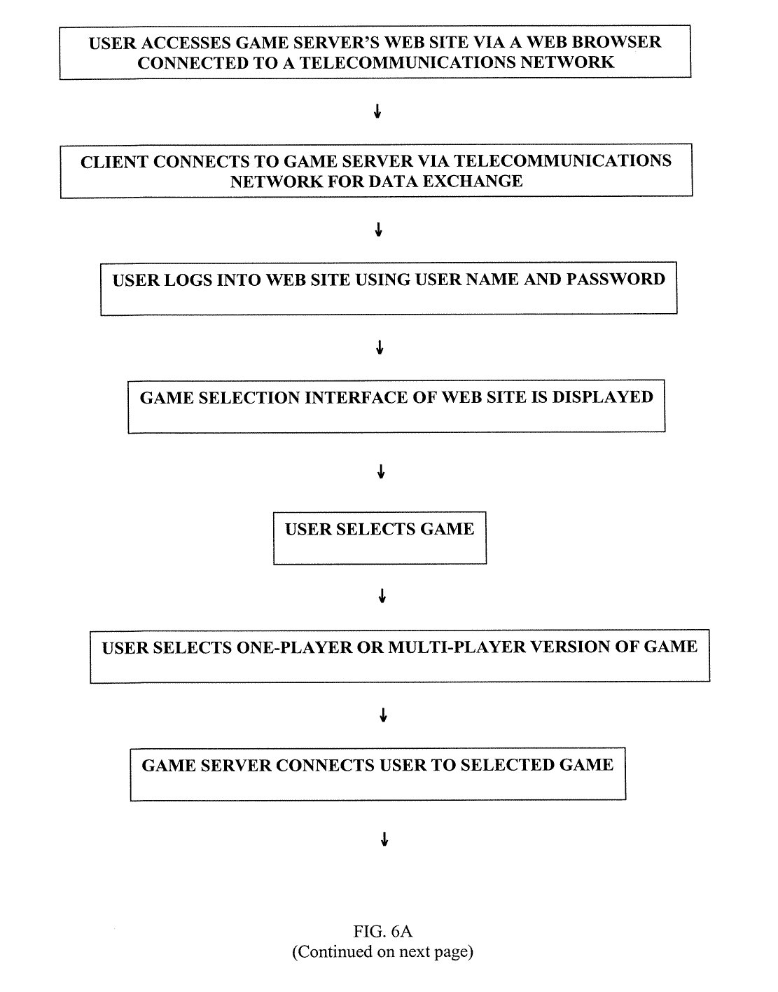

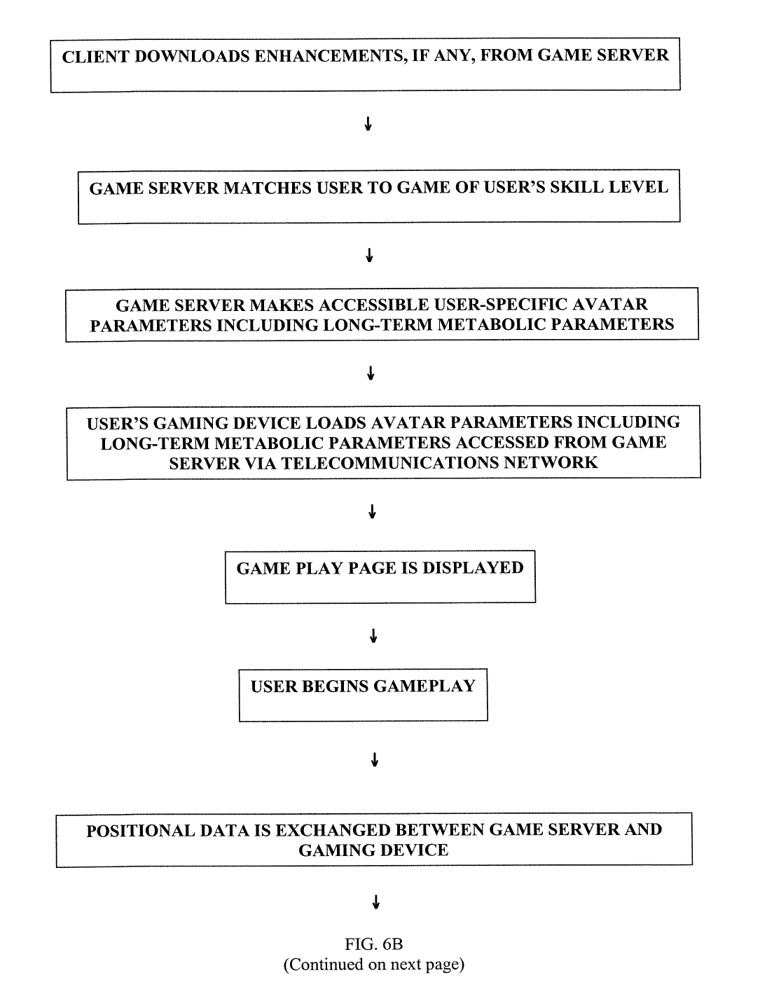

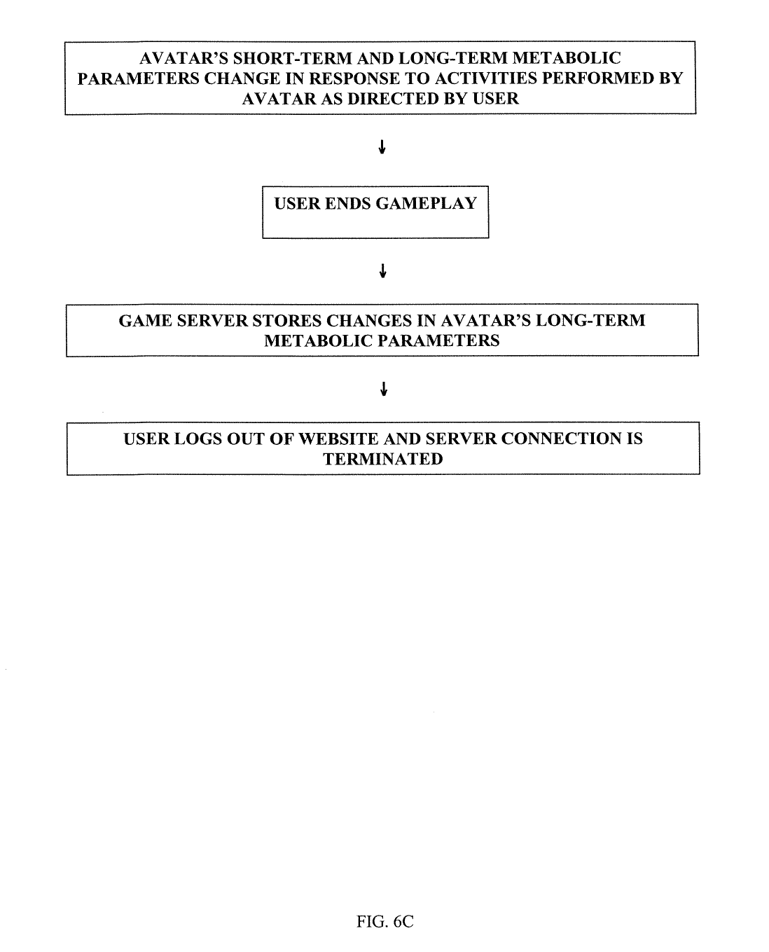

After installation is complete, the user logs into the web site using the user name and password chosen by the user during registration. This step and the following steps, as shown in FIGS. 6A-6C, are performed each time a user accesses the electronic game after the initial registration and software download and installation. After successfully logging into the electronic game through the web site, a game selection interface is displayed. On this interface, the user indicates which sports game of the electronic game the user wishes to play, for example, tennis, bobsledding, basketball, or skiing, among others. The user also selects whether the user wishes to play a one-player or a multi-player version of the selected sports game. Where the user selects the one-player version of a sports game, the user's avatar will compete against computer-controlled avatars. However, where the user selects the multi-player version of a sports game, the user's avatar will compete against avatars controlled by other users. After the type of game is selected by the user, the game server connects the client to the selected game.

In another step of the method, the client downloads enhancements and updates, if any, for the client-side software. Enhancements may include changes to the metabolism parameters or to the avatar.

Next, the game server matches the user to an instance of the selected sports game in the user's specific skill level. The game server also makes accessible to the client certain user-specific parameters including long-term metabolic parameters for the user's avatar. The client downloads the avatar parameters including long-term metabolic parameters from the game server via the telecommunications network. A game play page is displayed and the user is able to begin gameplay.

As the user controls the avatar during gameplay of the selected sports game, positional data is exchanged between the game server and the client, or gaming device. The avatar's short-term and long-term metabolic parameters, which are affected by the avatar's user-selected actions and monitored and calculated by the client-side software, change in response to activities performed by the avatar during gameplay and during exercise, training, virtual food consumption, and hydration. Once the sports game is complete, or alternatively, during the sports game, the user may end gameplay. When gameplay is ended, the client uploads data pertaining to changes in the avatar's long-term metabolic parameters to the game server for storage. In this way, the avatar's skill level and long-term metabolic parameters are stored and reused in subsequent gameplay by the user so that the user can experience the avatar's improvement or diminishment of athletic abilities and overall fitness. The user can then log out of the web site and the client connection to the game server is terminated.

In another step of the method, the user is permitted to select the quantity and types of food consumed by the avatar. In this step, the foods available for selection by the user include virtual food in the electronic game that simulates real-life nutritional properties. Similarly, the method also includes a step in which the user is permitted to select the quantity and types of liquid beverage consumed by the avatar. The liquid beverage may include virtual liquid beverages in the electronic game that simulate real-life nutritional properties when “consumed” by the avatar such as, for example, the ability of a real-life energy drink to increase an athlete's energy and alertness due to the sugar and caffeine content.

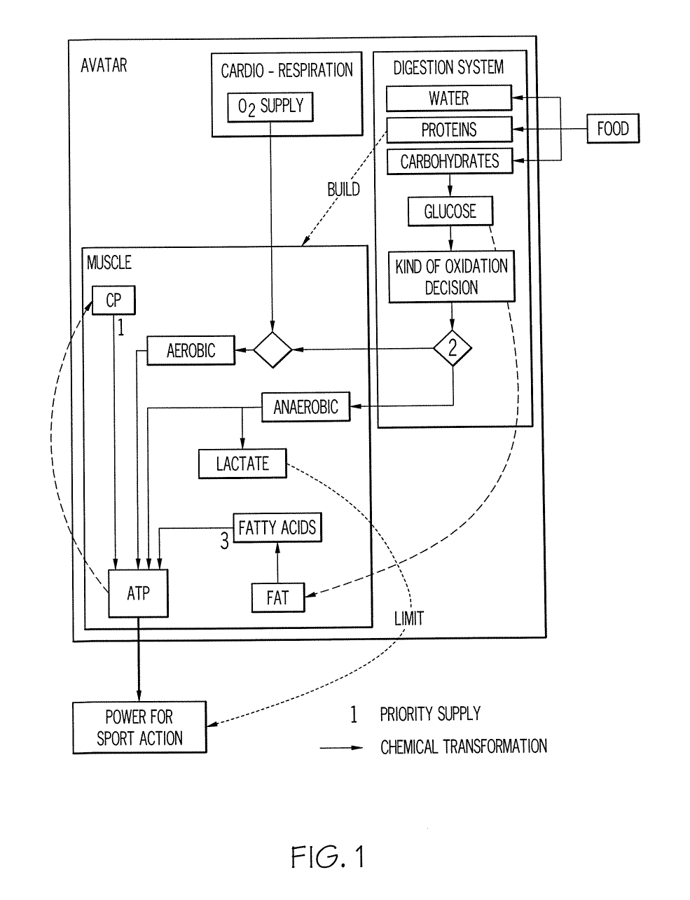

In another step of the method, the quantity of virtual food that the avatar must consume is programmed to be dependent upon the avatar's muscle volume. The avatar's total mass is changed as a variable that is dependent upon the quantity and types of food and liquid beverage selected by the user for consumption by the avatar. As the avatar is directed by the user to consume virtual food and virtual liquid beverage, the electronic game assigns values for the quantities of water, proteins, and carbohydrates into which the virtual food and beverage can be converted for use in powering the avatar's athletic performance. For example, the value (quantity) of carbohydrates consumed by the avatar as part of the virtual food may be calculated by the electronic game as a predetermined number of units of virtual glucose which may then be used by the avatar to produce virtual energy units, for example, virtual ATP, for accomplishing an athletic effort by the avatar. FIG. 1 provides a schematic illustration of the way in which virtual food and oxygen supply are used by the avatar to produce energy units in the form of virtual ATP to power the avatar's performance in sport-related actions.

The principles and algorithms of the avatar's virtual metabolism can be understood more clearly from the further details provided in the following tables, which include examples of the mathematical formulas used by a metabolism engine downloaded from the game server and installed on the client computer to monitor and calculate the avatar's virtual metabolism parameters.

In the electronic game, and with respect to the avatar's virtual metabolism, the following principles and/or algorithms are applicable:

TABLE 1
Consumption of Carbohydrates.

$\frac{{dq}_{c}}{dt} = - {k}_{c} , {q}_{c} -> \begin{matrix}{q}_{c} = {q}_{co} if t < {T}_{digestion} \\ {q}_{ c} = {q}_{co} \cdot {e}^{- kc ( t - T digestion )} si t > {T}_{digestion}\end{matrix}$
The constant Kc is to be determined (tuning)
q_{c0} is the quantity of carbohydrates absorbed by the avatar

TABLE 2
Glucose and Fat in Body Calculation.

```
Glucose in digestion system calculus [g]:
    Glucose in digestion system(t + δt) = Carbohydrates from eating (t + δt) + Glucose
    in digestion system(t) − Glucose in digestion to glucose storage(t) × δt × 180/
    1000
Glucose in digestion system calculus [mmol]:
    Glucose in digestion system(mmol) = Glucose in digestion system(g) × 1000/180
Glucose in digestion to glucose storage calculus [Hz]:
    Glucose in digestion to glucose storage = (1 − Actual glucose[mmol]/Normal Glucose
    level) × Glucose in digestion system[mmol] × Glucose digestion rate
For δt = 10 s,
    Glucose in digestion to glucose storage = (1 − Actual glucose(mmol)/Normal Glucose
    level) × Glucose in digestion system[mmol] × (1 − exp (−δt * Glucose digestion rate))
    (The proportion of actual glucose/normal glucose varies with t.)
Transfer to fat storage calculus [mmol/s]:
    Transfer to fat storage = “Glucose” in digestion system [mmol] × Fat storage transfer
Fat storage calculus [mmol]:
    Fat storage (t + δt) = Fat storage(t) + (Transfer to fat storage(t) − Actual ATP supply from
    fatty acid(t + δt)) × δt
Fat calculus [g]:
    Fat = (Fat storage/ATP available per g of fatty acid)/1000
```

TABLE 3
Energy for Muscle.

```
Energy [Joule]
    Energy = Performance × δt
ATP needed [mmol]
    ATP needed = (Energy/Energy release per mmol ATP)/Energy
    efficiency
```

TABLE 4
Aerobic/Anaerobic ATP Production.

```
Maximum supply of oxygen (O₂) in a specific muscle:
    Max. O₂ supply = O₂ supply per muscle weight × Muscle mass
O₂ need for aerobic supply of ATP + CP restoration calculus:
    If {ATP needed/(31/6) = 0 and CP to be restored > 0} →
    O₂ need for aerobic supply of ATP + CP restoration = Max. O₂ supply
    Else →
    O₂ need for aerobic supply of ATP + CP restoration = ATP needed/(31/6)
Oxygen supply in a muscle calculus:
    O₂ supply(t + δt) = O₂ supply(t) + Delta O₂
Delta O₂
    Delta O₂ = [Min(Max. O₂ supply, O₂ needed for aerobic supply of ATP and CP
    restoration(t)) − O₂ supply (t)] × (1 − exp(−δt * O₂Rate)).
Theoretical heart rate [1/min]
    Theoretical heart rate = Minimum heart rate + (1 − e^{- ATP needed / Heart rate parameter}) × (Maximum
    heart rate − Minimum heart rate)
Delta heart rate
    Delta heart rate (t + δt) = (Theoretical heart rate(t + δt) − Actual heart rate(t)) × Heart rate
    kinetic rate
Actual heart rate [1/min]
    Actual heart rate(t + δt) = Actual heart rate(t) + Delta heart rate (t + δt)
```

TABLE 5
CP Consumption Calculation.

```
Actual CP level calculus [mmol]:
    Actual CP level(t + δt) = Max(Actual CP level (t) −
    (Actual CP/ATP supply(t) + CP restoration rate(t)) × δt,
    CP restoration rate(t) × δt)
Possible CP/ATP supply calculus [mmol/s]:
    Possible CP/ATP supply = Min(Actual CP level, Max. CP supply)
Actual CP/ATP supply calculus [mmol/s]:
    Actual CP/ATP supply = Min(Possible CP/ATP supply, ATP needed)
Remaining ATP need to cover calculus:
    Remaining ATP need to cover(t + δt) = ATP needed (t + δt) −
    Actual CP/ATP supply(t + δt) + CP restoration rate(t)
```

TABLE 6
CP Restoration Calculation.

```
CP to be restored [mmol]
    CP to be restored = Normal CP level − Actual CP level
CP restoration rate [mmol/s]
    a = CP restoration limit − Energy(t + δt)/δt
    b = Min(CP to be restored(t + δt) × CP restoration factor,
    ATP recoverable from fatty acid(t) + ATP coverable
    from aerobic oxidation(t)
    CP restoration rate(t + δt) =
        If (0 < a)
          Then b
        Else 0
CP restored
    CP recovered + Min(CP to be restored(t + δt),
    ATP coverable from fatty acid(t) + ATP coverable from aerobic
    oxidation(t)) * (1 − exp (−δt/CPrestorationFactor))
```

TABLE 7
Glycolic Oxidation - Anaerobic Case.
Glucose → 3 ATP + Lactate

TABLE 8
Production of Glucose.

$\begin{matrix}\frac{{dq}_{G}}{dt} = {k}_{c} \cdot {q}_{c} - {k}_{G}^{anaerobic} \cdot {q}_{G} -> \\ \begin{matrix}{q}_{G} = 0 if t < {T}_{digestion} \\ {q}_{G} = \frac{{q}_{co}}{\frac{{k}_{G}^{anaerobic}}{{k}_{c}} - 1} \cdot ( \begin{matrix}{e}^{- kc \cdot ( t - Tdigestion )} - {e}_{G}^{- k anaerobic} \cdot \\ ( t - {T}_{digestion} )\end{matrix} ) t > {T}_{digestion}\end{matrix}\end{matrix}$
Production of ATP and Lactate can be calculated:

$\frac{{dq}_{Lactate}}{ } = \frac{1}{3} \cdot \frac{{dq}_{ATP}}{dt} = {k}_{G}^{anaerobic} \cdot {q}_{G}$

${q}_{ATP} = 3 \cdot {q}_{Lactate} = 3 \cdot {q}_{Co} \cdot 1 - \frac{\begin{matrix}{k}_{G}^{anaerobic} \cdot {e}^{- kc \cdot ( t - Tdigestion )} - \\ {k}_{c} \cdot {e}^{- kGanaerobic} \cdot ( t - {T}_{digestion} ) )\end{matrix}}{{k}_{G}^{anaerobic} - {k}_{c}} t \geq {T}_{digestion}$
T_{digestion} = the time needed for the muscle to get the food
k_{c} = The speed of carbohydrates consumption
k_{G}^{anaerobic} = The speed of glucose consumption in the anaerobic case
q_{Co} = the quantity of food absorbed
V_{muscle} = volume of the muscle

TABLE 9
Anaerobic Calculus.

```
ATP coverable from anaerobic oxidation [mmol/s]
    ATP coverable from anaerobic oxidation(t + δ) =
    Min(Lactacidic ATP supply, Actual glucose(t)/δt)
ATP covered via anaerobic oxidation [mmol/s]
    ATP covered via anaerobic oxidation = Min(ATP coverable
    from anaerobic oxidation, Remaining ATP need to cover)
Lactate produced [mmol/s]
    Lactate produced = ATP covered via anaerobic oxidation × 2/3
Lactate decomposed [mmol/s]
    Lactate decomposed(t + δt) = Total lactate(t) ×
    (1 − exp(−δt × Lactate decomposition rate) ×
    (1 − e^{- {Power provided} / Power normalization factor}))
where Lactate decomposition rate is expressed in Hz.
Total lactate [mmol]
    Total lactate(t + δt) = Total lactate(t) + Lactate produced(t) × δt −
    Lactate decomposed(t + δt)
Glucose used [mmol/s]
    Glucose used = ATP covered via anaerobic oxidation/3
    Actual glucose(t + δt) = Actual glucose(t) −
    [Glucose used^{Aerobic}(t) ⁻ Glucose used^{Anaerobic}(t) +
    Glucose in digestion to glucose storage(t)] × δt + Lactate
    decomposed(t) × Share of decomposed lactate used as energy
```

TABLE 10
Glycolic Oxidation - Aerobic Case.

O₂ + glucose → 31 ATP

$\frac{1}{31} \cdot \frac{{dq}_{ATP}}{dt} = {k}_{G}^{aerobic} \cdot {q}_{G} \cdot {q}_{O 2}$

TABLE 11
Approximation of O₂ (t).
${q}_{ATP} = 31 \cdot {q}_{O 2}^{sat} \frac{{q}_{co} - {e}_{O 2}^{- ( q sat )} - {q}_{co} \cdot {k}_{G}^{aerobic \cdot t}}{1 - {e}_{O 2}^{- ( q sat )} - {q}_{co} \cdot {k}_{G}^{aerobic \cdot t}}$

TABLE 12
Aerobic Calculus.

```
ATP coverable from aerobic oxidation [mmol/s]
    ATP coverable from aerobic oxidation = Min (Actual O₂ supply ×
    31/6, Aerobic ATP supply)
Actual ATP supplied via aerobic oxidation [mmol/s]
    Actual ATP supplied via aerobic oxidation = Min(ATP coverable
    from aerobic oxidation, Remaining ATP need to cover)
Glucose used [mmol/s]
    Glucose used = Actual ATP supplied via aerobic oxidation/31
Remaining ATP need to cover
    Remaining ATP need to cover Glucose = Remaining ATP need to
    coverFat − Glucose used
```

TABLE 13
Fat to ATP Calculus.

```
ATP supply from fatty acid = Muscle mass × ATP supply from fatty acid
Fatty acid rate level
    If anaerobic →
    Fatty acid rate level (t + δt) = Fatty acid rate level(t) × (1 − Fat rate counter speed × Anaerobic
    decay accelerator)
    If aerobic →
        If Energy(t + δt)/δt > 0 →
        Fatty acid rate level (t + δt) = Fatty acid rate level(t) × (1 − Fat rate counter speed) + Fat
    rate counter speed
    Else →
        Fatty acid rate level (t + δt) = Fatty acid rate level(t) × (1 − Fat rate counter speed)
Fat rate counter speed must be function of δt so if an exponential decrease is desired:
    Fatty acid rate level (t + δt) = Fatty acid rate level(t) × (1 − exp(− Fat rate counter period × δt)) + fat
    rate counter speed × δt if aerobic and power provided,
    Where fat rate counter period is multiplied by Anaerobic decay accelerator if anaerobic
Actual ATP level from fatty acid [mmol]
    Actual ATP level from fatty acid = Normal fatty acid level
ATP coverable from fatty acid [mmol/s]
    ATP coverable from fatty acid = Min(Actual ATP level from fatty acid, Fatty acid rate
    level) × ATP supply from fatty acid
Actual ATP supply from fatty acid [mmol/s]
    Actual ATP supply from fatty acid = Min(ATP coverable from fatty acid, Remaining
    ATP need to cover)
Remaining ATP need to cover
    Remaining ATP need to cover_{Fat}(t) = Remaining ATP need to cover_{CP}(t) − Actual ATP
    supply from fatty acid [mmol/s](t)
```

TABLE 14
General Formulas.

```
Muscle Mass [kg]
    Muscle Mass = Total Mass × Muscle Share
CP Storage [mmol]
    CP Storage = CP ratio × Total Mass
Muscle Glycogen [g]
    Muscle Glycogen = Glycogene share in muscle × Muscle Mass × 1000
Total glycogen [g]
    Total glycogen = Muscle glycogen + Liver glycogen + Blood glycogen
Total glucose storage [mmol]
    Total glucose storage = Total glycogen × 180/1000
Amount of body fat/fatty acid [g]
    Amount of body fat/fatty acid = Body fat share × Total Mass × 1000
Total fatty acid storage [mmol ATP equivalent]
    Total fatty acid storage = (Amount of body fat/fatty acid) × (ATP available per g of fatty
    acid) × 1000
O₂ supply per muscle weight [mmol/(s*kg)]
    O₂ supply per muscle weight = Max. O₂ uptake/60 × 0.045
Normal CP level [mmol]
    Normal CP level = CP storage
Max. CP supply [mmol/s]
    Max. CP supply [mmol/s] = Max. CP supply [mmol/(s*kg)] × Muscle mass [kg]
ATP supply from fatty acid [mmol/s]
    ATP supply from fatty acid [mmol/s] = ATP supply from fatty acid [mmol/(s*kg)] × Muscle
    mass [kg]
Aerobic ATP supply [mmol/s]
    Aerobic ATP supply [mmol/s] = Aerobic ATP supply [mmol/(s*kg)] × Muscle mass [kg]
Lactacidic ATP supply [mmol/s]
    Lactacidic ATP supply [mmol/s] = Lactacidic ATP supply [mmol/(s*kg)] × muscle mass
    [kg]
Absolute muscle lactate limit [mmol]
    Absolute muscle lactate limit [mmol = Muscle lactate limit [mmol/kg] × Muscle mass
    [kg]
```

TABLE 15
Power Test.

```
Remaining ATP need
    Remaining ATP need + Remaining ATP need to
    cover^{Glucose Aerobic Oxidation} − ATP covered via
    anaerobic oxidation^{Glucose}
ATP from CP [mmol/s]
    ATP from CP = Actual CP/ATP supply^{Metabolism Fat}
ATP from fatty acid [mmol/s]
    ATP from fatty acid = Actual ATP supply from fatty acid^{Metabolism Fat}
ATP from aerobic [mmol/s]
    ATP from aerobic = Actual ATP supplied via aerobic oxidation^{Glucose}
ATP from anaerobic [mmol/s]
    ATP from anaerobic = ATP covered via anaerobic oxidation^{Glucose}
```

TABLE 16
Avatar Muscle Development (Function of Time).

Principle has two form parameters: first, stagnation length, then, speed
of decrease:
X_{Decreased}(t) =

X_{stagnation+}, t < t_{BeginDecrease}
X_{Stagnation+} + (X_{Stagnation-} − X_{Stagnation+}) f(t − t_{BeginDecrease}),
tε[t_{BeginDecrease}; t_{BeginDecrease} + δt]
∀X_{Stagnation-} + (X_{Stagnation+} − X_{Stagnation-}) f(t_{StopDecrease} − t),
∀tε[t_{BeginDecrease} + δt; t_{StopDecrease}]
X_{Stagnation-}, ∀t > t_{StopDecrease}
With:
$f ( t ) = \frac{1}{1 + {α}^{′}} \cdot {t}^{2} + \frac{{α}^{′}}{1 + {α}^{′}} {t}^{3}$

$δt = \frac{{t}_{StopDecrease} - {t}_{BeginDecrease}}{2}$

In another embodiment, the method also includes a step for powering the avatar's performance of virtual athletic actions by instructing the avatar to produce virtual energy by metabolizing stored virtual creatine phosphate, stored virtual glucose, stored virtual fatty acids, other stored virtual energy molecules, or combinations of one or more of the same.

In one embodiment, the method includes a step in which the avatar's performance of virtual athletic actions is powered by instructing the avatar to produce virtual energy by metabolizing stored virtual glucose, which in the electronic game is a virtual energy unit, through simulated aerobic respiration when the avatar has performed virtual athletic actions to oxygenate the avatar's virtual muscle. In another embodiment, the avatar's performance of virtual athletic actions is powered by instructing the avatar to produce virtual energy by metabolizing stored virtual glucose through simulated anaerobic respiration when the avatar requires immediate access to virtual energy and the avatar has not performed virtual athletic actions to oxygenate the avatar's virtual muscle. The electronic game may include a series of virtual “warming-up” activities or exercises for the avatar to complete to achieve better performance once competition in the game begins.

In one step of the method, the computer is used to calculate and monitor the value of the at least one metabolic parameter. The value of the metabolic parameter calculated and monitored by the computer is altered based upon the input of user-selected actions in conjunction with predetermined metabolic parameter effects. For example, as the user controls the avatar to cause the avatar to perform certain actions such as exercise, the virtual heart rate of the avatar can be increased. In this way, the performance of the avatar may be changed in connection with changes in the value of the metabolic parameter that is being monitored and calculated. In another example, the user may direct the avatar to consume a virtual energy beverage or food item that increases the stamina, ATP supply, or muscle mass of the avatar.

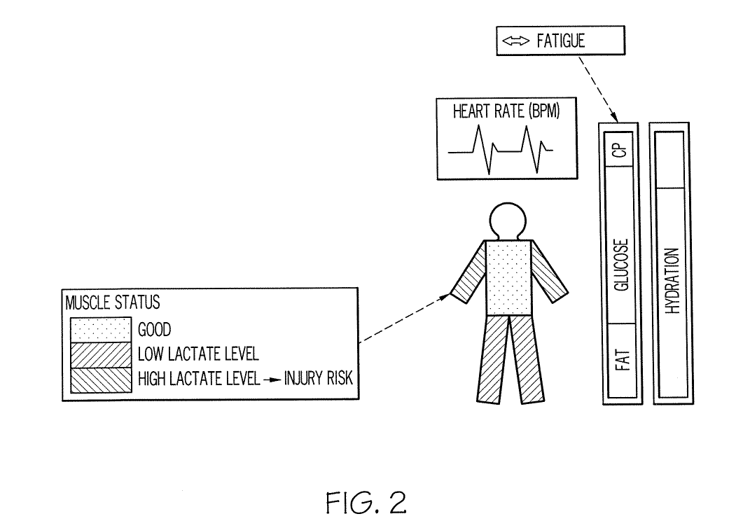

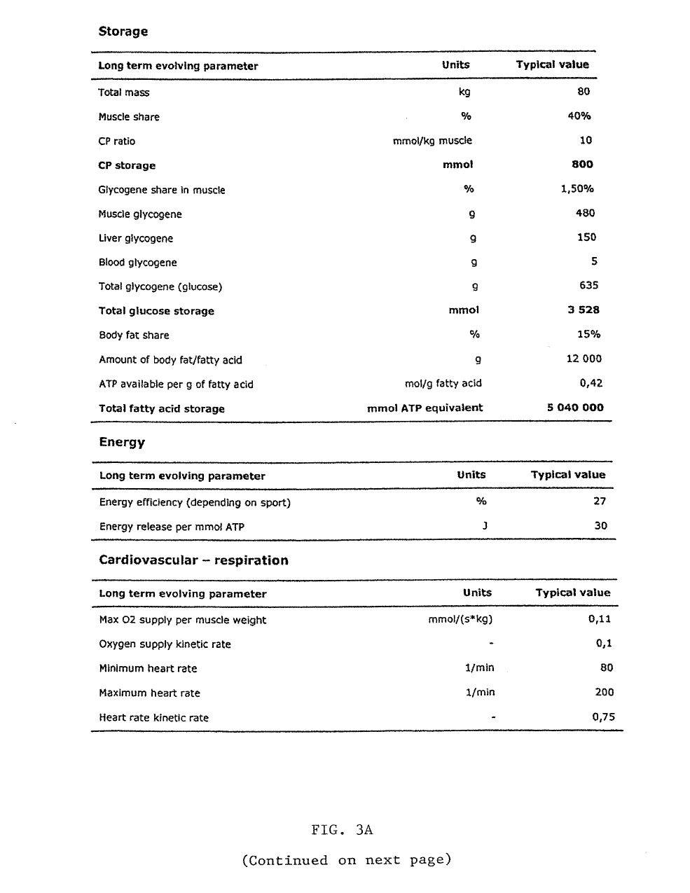

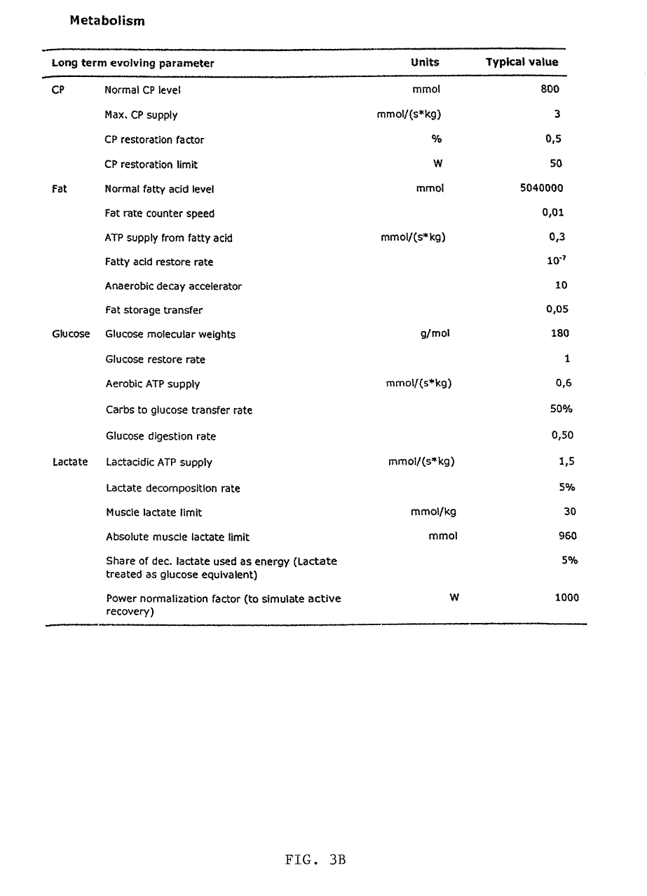

The electronic game further includes one or more metabolism gauge displays, such as the ones illustrated in FIG. 2, to provide the user with information concerning the metabolic parameters calculated and monitored by the electronic game. The metabolic parameters that are monitored and calculated by the electronic game can include the avatar's muscle status, heart rate, fatigue level, and hydration. Each of the metabolism gauges may be used to collectively regroup and visually represent the quantities or levels associate with two or more virtual metabolism parameters. In one embodiment, the levels indicated by each metabolism gauge are schematically represented, for example, by bars or meters that change in length or color, to show the user fluctuations in each level. In another embodiment, the metabolism gauges may show numeric values for each metabolic parameter. FIGS. 3A-3B demonstrate typical values that may be used for some virtual metabolism parameters of the electronic game. These typical values and units are provided for illustrative purposes only and may vary depending upon the desire of either the user or of a programmer or manufacturer who creates the electronic game.

In one embodiment, the muscle status gauge for the avatar includes an indication of the level of lactate present in various virtual muscle groups. A low lactate level present in a virtual muscle group signals to the user that the avatar needs rest, virtual food, or to complete additional warming-up activities prior to beginning another round of gameplay. A high lactate level in a virtual muscle group, as indicated on the muscle status gauge, signals to the user that the avatar's source of energy (virtual ATP) is depleted and that the avatar is at an increased risk of injury.

In another embodiment, the fatigue gauge for the avatar includes one or more visual indicators displaying the avatar's supply of energy units. Within the fatigue gauge display, visual indicators are included for the avatar's levels of one or more of fatty acid, glucose, ATP, and creatine phosphate.

In one embodiment, the method may include a step in which the avatar is equipped with a plurality of muscle group parameters. In an exemplary embodiment, the muscle group parameters include two types: slow-twitch (or type I) virtual muscles and fast-twitch (or type II) virtual muscles. In an exemplary embodiment, each of the plurality of muscle groups contains at least one type of virtual muscle selected from among type I virtual muscles that are fatigue-resistant for long-term athletic performance by the avatar and type II virtual muscles for short-term athletic performance by the avatar. A first muscle power parameter (slow-twitch, or type I, power) and a second muscle power parameter (fast-twitch, or type II, power) may be assigned to each of the plurality of muscle groups. The type I muscle power parameter can encompass a range of values related to the percentage of the avatar's virtual muscle mass dedicated to performing slow and long-term athletic performance, while the type II muscle power parameter can encompass a range of values related to the percentage of the avatar's virtual muscle mass dedicated to performing fast and immediate athletic performance. In one embodiment, the value assigned for each parameter may be selected from a range of 1 to 100. Type I and type II muscle power parameters are calculated, monitored, and assigned to both a “legs and bottom” virtual muscle group and an “arms and shoulders” virtual muscle group of the avatar.

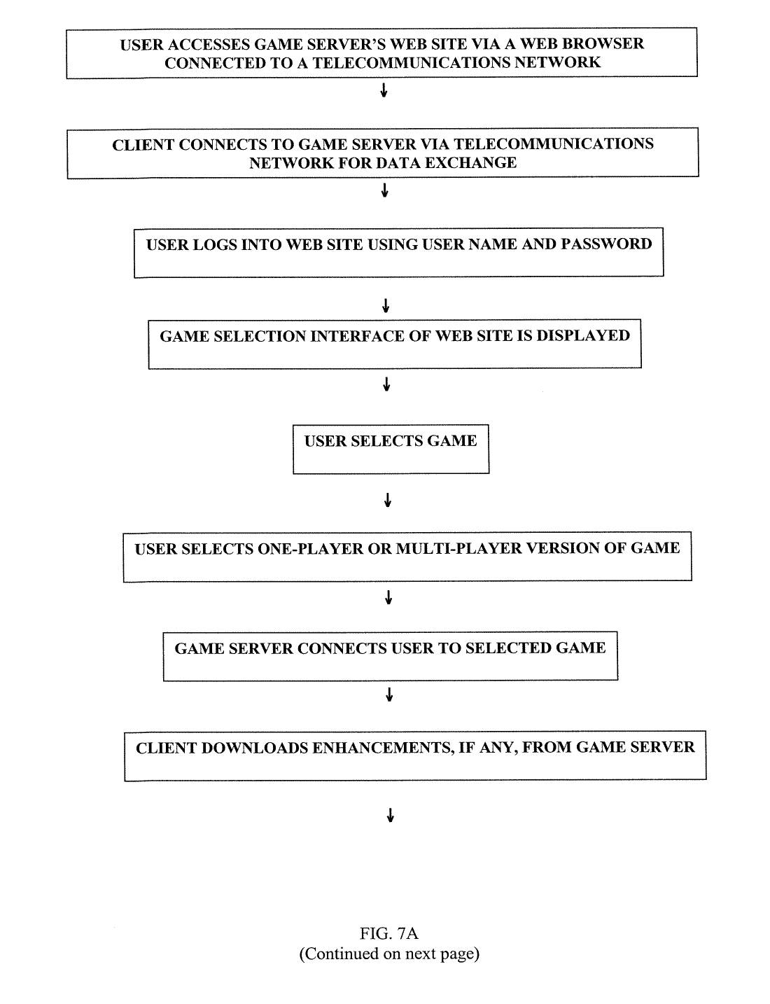

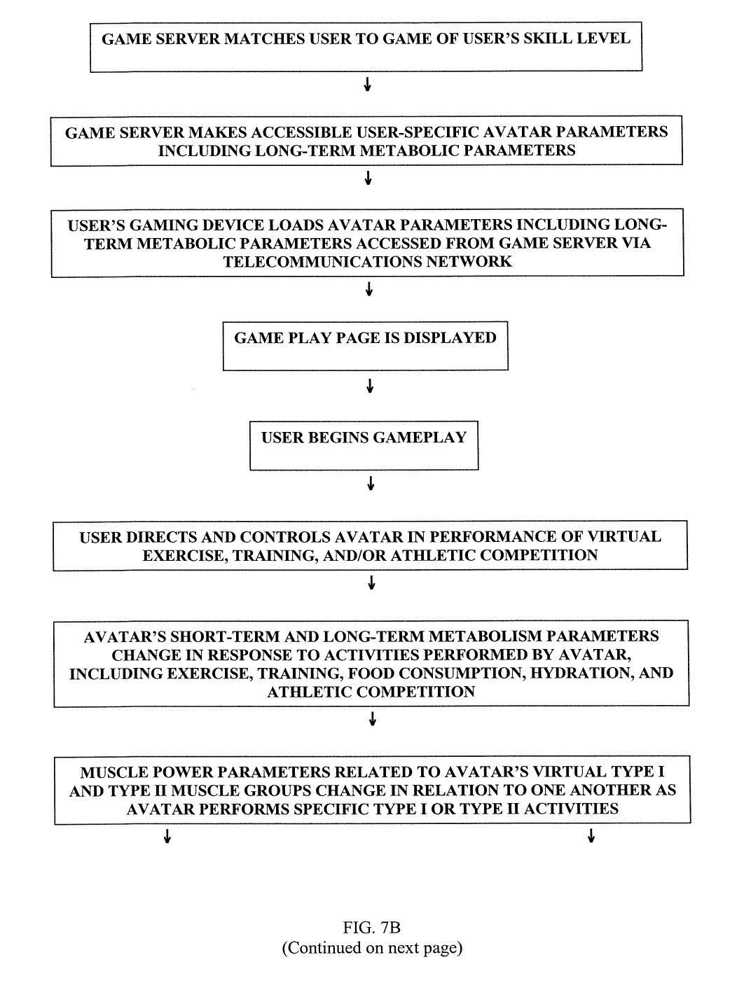

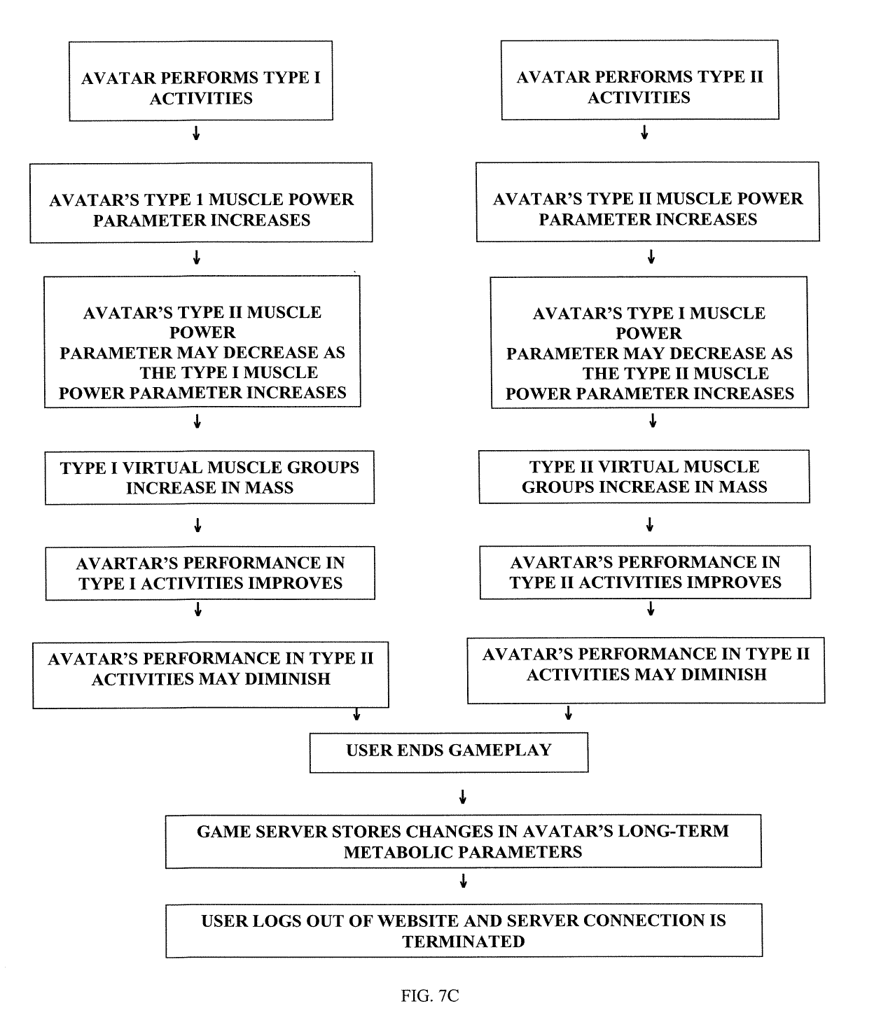

The sum of the two muscle power parameters can be used to determine a total muscle mass parameter for the avatar. However, the highest value for the total muscle mass parameter is programmed to be less than the sum total of the values for the type I and type II muscle power parameters. Therefore, where the range of values for the type I and type II muscle power parameters is 0 to 100, the upper limit of the total muscle mass parameter might be restricted to a value that is less than the sum total of the first and second muscle power parameters, for example, 150. In this way, as indicated in FIGS. 7A-7C, the avatar's virtual type I and type II muscle groups develop in parallel so that as one muscle power parameter increases the other muscle power parameter decreases. For example, if the user engages the avatar in many type I leg-training activities within the electronic game so that the avatar achieves a value of 90 for the type I muscle power parameter, the avatar will only be able to achieve a maximum value of 60 for the type II muscle power parameter.

In a more specific example, if the user wishes to train the avatar to be an excellent marathon runner in the electronic game, the avatar must engage in type I leg-training activities to reach or come near to the maximum value (which is, for purposes of this example, 100) for the type I parameter. As the avatar's type I parameter increases toward the maximum value, the type II parameter necessarily decreases toward a mid-range value (50 in this example). In this way, the user's avatar is more similar to a real human athlete in that the avatar cannot be the best performer in every sport. If the avatar engages in type I leg-training sports and exercises, the avatar will perform well in distance running but will decrease in performance ability in type II activities such as sprinting. When the user wishes to increase the type II parameter for the avatar, the user need only to engage the avatar in type II leg-training activities.

In one embodiment of the method, users having lower skill levels will not be frustrated by decreases in one parameter as the other parameter increases because for these types of users the one parameter will already have a low value rather than a high value. Users having higher skill levels will be affected by the parallel development of the avatar's virtual muscle groups due to the greater likelihood that a highly skilled user's avatar will have muscle power parameters closer to the maximum value defined for at least one of the parameters.

Type I virtual muscles generate muscle using a virtual aerobic process in which virtual ATP are generated and split at a slow rate. The type I virtual muscles are programmed to have a slower contraction velocity and are ideal for avatar activities such as long distance running by the avatar in the electronic game. For example, the avatar can be programmed to use type I virtual muscles in the “legs and bottom” virtual muscle group in performing all actions directed by the user in electronic games related to skiing, bobsledding, basketball, and tennis. The avatar's type I virtual muscles in the “arms and shoulders” virtual muscle group are not activated when the user directs the avatar to engage in, for example, skiing and bobsledding where only minimal usage of the “arms and shoulders” muscle group is required.

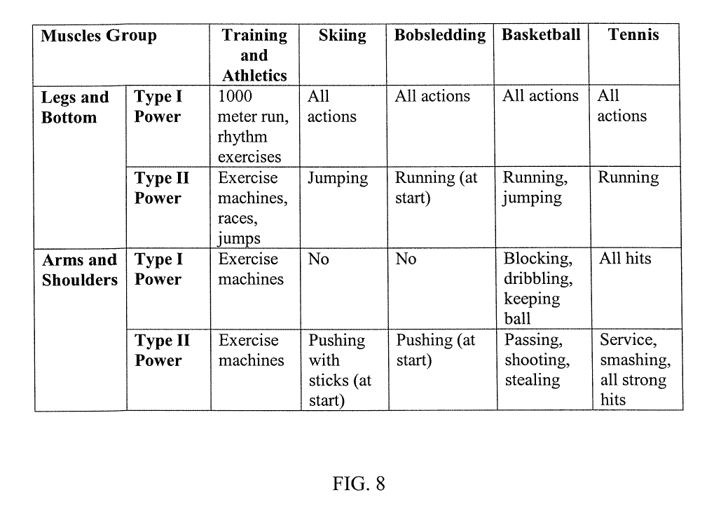

Type II virtual muscles, on the other hand, are programmed to fatigue quickly when used by the avatar and are useful for virtual sport activities performed by the avatar such as sprinting. The avatar can be further programmed to use type II virtual muscles in the “legs and bottom” virtual muscle group in performing jumps in skiing and basketball and in running during bobsledding, basketball, and tennis, all of which require the avatar's substantial use of the aforesaid virtual muscle group. As shown in FIG. 8, the avatar is programmed to use type II virtual muscles in the “arms and shoulders” virtual muscle group when performing activities in the electronic game that require use of that particular virtual muscle group. For example, the type II “arms and shoulders” muscles are used when pushing during skiing and bobsledding, when passing, shooting, and stealing the ball during basketball, and when serving, smashing, and during all strong hits.

In a simplified version of the avatar, no distinction is made between fast-twitch and slow-twitch muscles for a “torso and back” virtual muscle group of the avatar. However, the “legs and bottom” virtual muscle group and the “arms and shoulders” virtual muscle group of the avatar do include distinct and separate fast-twitch and slow-twitch virtual muscles as indicated in FIG. 8.

In another embodiment, the method includes the step of training the avatar through user-selected actions. Such user-selected actions might include controlling the performance of the avatar in a training routine that can be completed by the avatar prior to beginning competitive gameplay. The method also includes the step of improving the avatar's athletic performance through the performance of virtual athletic actions. In one step, a maximum muscle mass that can be attained by the avatar can be defined.

In another step of the method, each of the plurality of muscle groups is assigned a third muscle power parameter that encompasses the maximum muscle mass that can be attained by the avatar. The third muscle power parameter can be defined as a sum of the type I and type II muscle power parameters. Once maximum muscle mass has been attained by the avatar, the type I and type II muscle power parameters can be linked so that an increase in one muscle power parameter causes a corresponding decrease in the other muscle power parameter to ensure that a predetermined value for maximum muscle mass cannot be exceeded.

In an exemplary embodiment of the method, the method includes a step for making available for purchase by the user one or more virtual items that when purchased and used by the avatar improve the avatar's performance in the electronic game. These performance-enhancing virtual items may include simulated apparel, footwear, sports equipment, food, liquid beverages, and sports accessories. In one embodiment, the virtual items simulate real-life brands and may be used to advertise real-life brands within the game to the user. In another embodiment, the method further includes a step in which real-life versions of the virtual, or simulated, items are made available for purchase by the user. Real-life items that are sold through the electronic game to the user can be sport, fitness, or health-related to improve the overall athletic performance, health, and fitness of the user.

In an exemplary embodiment of the method, a single install file, which includes data and files, is downloaded to the client from the server via the telecommunications network to which both the client and server are connected. The single install file downloaded by the client includes one executable file (dll) per game within the electronic game, e.g., one executable for a tennis game, one executable for a basketball game, etc. The single install file also includes one or more utilitarian executable files used for, e.g., network communication setup and checking for updates; one or more configuration files used for, e.g., setting server IP addresses and game paths; a data file containing, e.g., all of the graphics, sounds, music, level description, and game scripts; one or more additional libraries used by the electronic game; and one or more files that are used to cache data to improve performance of the electronic game. The additional libraries include, for example, DirectX 9.0c, Mozilla, Ogg Vorbis, Xalan, Xerces, JavaScript support, GC, and ACE.

The method permits the avatar and other features, including the avatar's virtual metabolism, to be easily enhanced due to the code architecture of the software used to create the electronic game. For example, in the method, the avatar's virtual metabolism is defined and controlled by a single library on the client side (e.g., the user's computer), but also has a dedicated server on the server side that exchanges data with the client side via the telecommunications network. With this arrangement, an element of the virtual metabolism may be easily enhanced within the electronic game by a single function call because only a single location exists per electronic game to enact the virtual metabolism enhancements. The addition of new features to the virtual metabolism is also made easier in that there is only a single place in the code where the new feature interface will need to be coded. Each game downloaded and installed on the client side can then “call” the new (interface) features depending upon specific gameplay needs.

In an alternate embodiment, the electronic game does not include a telecommunications network.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for simulating real-life athletic performance in an electronic game, the method comprising the steps of:
(a) providing (i) an electronic game comprising software installed on a computer and (ii) one or more devices for playing, displaying, and allowing a user to interact with the electronic game; and
(b) equipping an avatar in the electronic game with a virtual metabolism comprising at least one metabolic parameter, wherein a user-selected action modulates the at least one metabolic parameter.

2. The method of claim 1, wherein the at least one metabolic parameter comprises a computer-simulated physiological metabolic process of a real human athlete.

3. The method of claim 2, wherein the simulated physiological metabolic process is selected from at least one of the group consisting of: avatar's total mass, muscle volume as a share of total mass, glycogen share in muscle, muscle glycogen level, liver glycogen level, blood glycogen level, total glycogen level, total glucose storage, body fat share of total mass, amount of body fat/fatty acid, adenosine triphosphate (ATP) available per grams of fatty acid, total fatty acid storage, energy efficiency, energy release per amount of ATP, maximum oxygen supply per muscle weight, oxygen supply kinetic rate, minimum heart rate, maximum heart rate, heart rate kinetic rate, normal creatine phosphate level, maximum creatine phosphate supply, creatine phosphate restoration factor, creatine phosphate restoration limit, normal fatty acid level, fat rate counter speed, ATP supply from fatty acid, fatty acid restore rate, anaerobic decay accelerator, fat storage transfer, glucose molecular weights, glucose restore rate, aerobic ATP supply, carbohydrates-to-glucose transfer rate, glucose digestion rate, lactacidic ATP supply, lactate decomposition rate, muscle lactate limit, absolute muscle lactate limit, share of lactate used as energy, power normalization factor to simulate active recovery, and hydration.

4. The method of claim 1, wherein the method further comprises at least one step selected from the group consisting of:
(c) permitting the user to select the quantity and types of food consumed by the avatar, wherein the food comprises virtual food in the electronic game comprising computer-simulated nutritional properties; and
(d) permitting the user to select the quantity and types of liquid beverage consumed by the avatar, wherein the liquid beverage comprises virtual liquid beverages in the electronic game comprising computer-simulated nutritional properties.

5. The method of claim 4, wherein the method further comprises at least one step selected from the group consisting of:
(e) requiring the avatar to consume a minimum amount of virtual food and depending the quantity of virtual food that the avatar must consume upon a muscle volume of the avatar; and
(f) changing the avatar's total mass as a variable that is dependent upon the quantity and types of food and liquid beverage selected by the user and consumed by the avatar.

6. The method of claim 3, wherein the method further comprises at least one step selected from the group consisting of:
(g) powering the avatar's performance of virtual athletic actions by instructing the avatar to produce virtual energy by metabolizing stored virtual creatine phosphate;
(h) powering the avatar's performance of virtual athletic actions by instructing the avatar to produce virtual energy by metabolizing stored virtual glucose;
(i) powering the avatar's performance of virtual athletic actions by instructing the avatar to produce virtual energy by metabolizing stored virtual fatty acids.

7. The method of claim 6, wherein step (i) of the method further comprises at least one step selected from the group consisting of:
(j) powering the avatar's performance of virtual athletic actions by instructing the avatar to produce virtual energy by metabolizing stored virtual glucose through simulated aerobic respiration when the avatar has performed virtual athletic actions to oxygenate the avatar's virtual muscle; and
(k) powering the avatar's performance of virtual athletic actions by instructing the avatar to produce virtual energy by metabolizing stored virtual glucose through simulated anaerobic respiration when the avatar requires immediate access to virtual energy and the avatar has not performed virtual athletic actions to oxygenate the avatar's virtual muscle.

8. The method of claim 1, wherein the electronic game comprises one or more metabolism gauge displays to provide the user with information concerning the at least one metabolic parameter, the at least one metabolic parameter being selected from at least one of the group consisting of: the avatar's muscle status, heart rate, fatigue level, and hydration.

9. The method of claim 1, wherein the method further comprises the step of:
(l) equipping the avatar with a plurality of muscle groups, wherein each of the plurality of muscle groups contains at least one type of virtual muscle selected from the group consisting of: slow-twitch virtual muscles that are fatigue-resistant for long-term athletic performance by the avatar and fast-twitch virtual muscles for short-term athletic performance by the avatar.

10. The method of claim 9, wherein the method further comprises the step of:
(m) assigning to each of the plurality of muscle groups (i) a first muscle power parameter comprising a range of values related to the percentage of the avatar's virtual muscle mass dedicated to performing slow and long-term athletic performance, and (ii) a second muscle power parameter comprising a range of values related to the percentage of the avatar's virtual muscle mass dedicated to performing fast and immediate athletic performance.

11. The method of claim 10, wherein the method further comprises at least one step selected from the group consisting of:
(n) training the avatar through user-selected actions;
(o) improving the avatar's athletic performance through the performance of virtual athletic actions;
(p) defining a maximum muscle mass that can be attained by the avatar with respect to changes in one or more muscle power parameters related to the development of the avatar's fast-twitch and slow-twitch virtual muscles;
(q) assigning to each of the plurality of muscle groups a third muscle power parameter comprising the maximum muscle mass that can be attained by the avatar and defining the third muscle power parameter as a sum of the first and second muscle power parameters; and
(r) once maximum muscle mass has been attained by the avatar, linking the first and second muscle power parameters so that an increase in one muscle power parameter causes a corresponding decrease in the other muscle power parameter so that a predetermined value for maximum muscle mass cannot be exceeded.

12. The method of claim 1, wherein the electronic game is accessible via a telecommunications network.

13. The method of claim 1, wherein the method further comprises the steps of:
(s) using the computer to calculate and monitor the value of the at least one metabolic parameter;
(t) altering the value of the at least one metabolic parameter based upon the input of user-selected actions in conjunction with predetermined metabolic parameter effects; and
(u) changing the performance of the avatar in connection with changes in the value of the at least one metabolic parameter.

14. An electronic game system comprising:
at least one server connected to a telecommunications network;
a computer, connected to the telecommunications network, comprising software means by which an electronic game is remotely accessed on the at least one server by a user;
a display device connected to the computer;
at least one input device connected to the computer;
a computer program means for controlling the computer so that the computer generates an avatar that is stored on the computer and controlled by manipulation of the at least one input device by the user, the avatar comprising a virtual metabolism;
a first data store associated with the server and configured to store user-specific long-term avatar metabolism parameters; and
a second data store associated with the computer and configured to store short-term avatar metabolism parameters.

15. A computer readable medium comprising:
a computer program means for controlling a computer so that the computer generates an electronic game comprising an avatar, wherein the avatar comprises a virtual metabolism comprising at least one virtual metabolic parameter, and wherein the at least one virtual metabolic parameter comprises a computer-simulated physiological metabolic process of a real athlete.

16. The computer readable medium of claim 15, wherein the avatar further comprises two types of virtual muscles: slow-twitch virtual muscles that are fatigue-resistant for long-term athletic performance by the avatar and fast-twitch virtual muscles for short-term athletic performance by the avatar.

17. A gaming device for marketing and selling at least one item displayed in an electronic game, the gaming device comprising:
a computer by which the electronic game is accessed by a user;
a display device connected to the computer;
at least one input device connected to the computer; and
an avatar stored on the computer and controlled by manipulation of the at least one input device by the user, the avatar comprising a virtual metabolism, wherein purchasing items being marketed and sold via the electronic game enhances the avatar's athletic performance in a virtual sport.

18. The device of claim 17, wherein the items being marketed and sold via the electronic game comprise both virtual items to be used by the avatar and corresponding real-life versions of virtual items for use by a human.

19. A method for simulating real-life athletic performance in an electronic game, the method comprising the steps of:
(a) providing (i) an electronic game comprising software installed on a computer and (ii) one or more devices for playing, displaying, and allowing a user to interact with the electronic game;
(b) equipping an avatar in the electronic game with a virtual metabolism comprising at least one metabolic parameter;
(c) controlling the performance of the avatar via user-selected actions that cause changes in a value of the at least one metabolic parameter; and
(d) making available for purchase by the user virtual items that when purchased and used by the avatar improve the avatar's performance in the electronic game.

20. The method of claim 19, wherein the method further comprises the step of:
(e) making available for purchase by the user real-life versions of the virtual items.

21. The method of claim 20, wherein the virtual items and real-life versions of the virtual items comprise real-life and simulated apparel, footwear, sports equipment, food, liquid beverages, and sports accessories.
